(19) United States
(12) Patent Application Publication
(10) Pub. No.: US 2024/0177126 A1
(43) Pub. Date: May 30, 2024

(54) SYSTEM AND METHOD FOR FACILITATING A CONNECTION BETWEEN TWO PARTIES

(71) Applicant: Help So Easy Inc., Montréal (CA)

(72) Inventor: Yuansang ZHA, Montréal (CA)

(21) Appl. No.: 18/521,918

(22) Filed: Nov. 28, 2023

Related U.S. Application Data
(60) Provisional application No. 63/385,331, filed on Nov. 29, 2022.

(51) Int. Cl. G06Q 20/10; G06Q 50/22

(52) U.S. Cl. CPC G06Q 20/102; G06Q 50/22

(57) ABSTRACT

A method can include receiving, from a second device to a first device, a search query for a helper profile. In addition, the method may include providing, from the first device to the second device, responsive to the search query, search results including a plurality of helper profiles based on the search query. The method may include receiving an indication of a selection of a first helper profile of the plurality of helper profiles. A request to communicatively connect the second device to a third device may be received. Also, the method may include generating a connection configuration for the second device to connect to the third device and sending the connection configuration to the second device. Accounts associated with the second device and third device can be updated to indicate a payment.

This application claims the benefit of priority to U.S. Provisional Patent Application No. 63/385,331 entitled “Multi-vendor online marketplace for human interaction through video and audio conversations,” filed on Nov. 29, 2022, the disclosure of which is hereby incorporated herein in its entirety.

### TECHNICAL FIELD

The present application is generally related to a system and method for facilitating an on-demand communication between two parties.

### BACKGROUND

Many people have specialized knowledge and skills which they could share with other people. Some people have specialized knowledge related to their work, hobbies, languages, cultures, places they have visited or lived, and so forth. Other people would like to receive help from someone with the knowhow but lack the ability to find the people willing to help.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates an example system environment for facilitating a connection between a client device and a helper device, in accordance with one or more embodiments.

FIG. 2 illustrates an example process flow for facilitating a connection between a client device and a helper device, in accordance with one or more embodiments.

FIG. 3 illustrates an example process flow for facilitating a connection between a client device and a helper device, in accordance with one or more embodiments.

FIG. 4 illustrates an example process flow for facilitating a connection between a client device and a helper device, in accordance with one or more embodiments.

FIGS. 5A, 5B, 5C, 5D illustrate example user interfaces for implementing the processes described with respect to FIGS. 3 and 4, in accordance with one or more embodiments.

FIG. 6 illustrates an example electronic system with which aspects of the subject technology may be implemented in accordance with one or more implementations.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring the concepts of the subject technology.

The ability to share knowledge effectively can be a roadblock to the quick dissemination of information from people with specialized knowledge or expertise, i.e., helpers, to people willing to pay for such information. From time-to-time, people need quick informational help, like health/legal advice, shopping/cooking tips, insider opinion, etc., which can be satisfied by a quick chat with someone in the relevant area for which the information is needed. These helpers may or may not be considered “experts.” In some instances, they may have particular knowledge they are willing to provide to another person, while in other instances they may just be willing to provide feedback for a survey or just to chat. It can be difficult to find people willing to help in such areas because there are no tools or platforms to facilitate the finding and connection between such helpers and people. People may not be able to find helpers easily and may end up spending much more time and money or may even get no answer at all.

Aspects of the current disclosure seek to resolve these issues by providing a system and method for facilitating a communication connection between two parties. Embodiments enable a burst market which allows individuals to sell any services at their chosen rate via video or audio chats lasting as short as a few seconds or minutes. One of the parties is a client seeking help and another of the parties is a helper willing to provide help. In response to providing this connection, the helper can be paid a fee by the client. The fee can be known up front and be guaranteed to the helper. To encourage quick communications that are to the point, the communication connection can be billed in very small increments of time or time-slice, such as every 1 second, 2 seconds, 3 seconds, 5 seconds, 10 seconds, 15 seconds, 20 seconds, 30 seconds, 60 seconds, 90 seconds, 180 seconds, combinations thereof, or the like. In some embodiments, the connection can be billed at actual time, down to the tenths, hundredths, thousandths, etc. place, such as 23.6439204 seconds. Very small incremental billing has a surprising effect of increasing client/helper connections. Because the barrier to participate is decreased, it is thought that clients feel more willing to take a chance or two on seeking out helpers because the cost is relatively low. In some aspects, a small grace period may be configured, for example, to allow for some polite introductory banter. For example, the system may provide a 3, 5, 10, or 20 second (or the like) grace period so that clients and helpers can exchange customary greetings. The grace period may be between 0 and 100 seconds, for example, though other values are contemplated and may be used.

In some aspects, rather than bill by an increment of time, the billing can be done by a per transaction fee, or a combination of a per transaction fee and an increment fee. In some aspects, rather than bill by an increment of time greater than or equal to 1 second, the billing can be done by actual time, down to the tenths, hundredths, thousandths, etc. place, such as 23.6439204 seconds. In other aspects, an auctioning system can be provided to allow clients seeking helpers to get help from a high-demand helper who is simply unable to accommodate all the helpers who would like to seek help from such a helper.

Further, in aspects of the current disclosure, the system can provide the ability to sign up to use the platform as a client seeking helpers and/or provide the ability to sign up to use the platform as a helper.

Upon receiving an indication indicating which helper the client would like to contact, the platform can secure and hold a pre-paid or pre-authorized payment from the client, which may be equivalent to a pre-defined block of time at the helper's designated rate. If during the session, the pre-authorized payment is exceeded by exceeding the pre-defined block of time, then the client can be pre-charged or pre-authorized for the same amount again, or for an additional higher amount.

The platform can facilitate a connection between the client and the helper. For example, the platform can use the communications capabilities of the client device and the helper device to initiate a direct connection over a network, such as the Internet. The connection may be a video connection, an audio connection, a virtual or mixed reality connection, or combinations thereof. The platform allows clients to talk directly to helpers without the need for human involved triage or call backs. The platform can monitor the connection progress, and upon completion of the connection can as soon as practical transfer an appropriate amount of money from the client to the helper or from the system to the helper on the client's behalf.

The platform allows helpers to set their own prices. In some aspects, the price can be variable based on a time of day or based on a duration of the communication. For example, during busier hours a helper may want to set the price higher. By further example, a helper may want to set a higher rate or lower rate for calls that exceed a certain duration. In some embodiments, rather than a time-based price, the helper can auction off a block of time or the helper can set a minimum price.

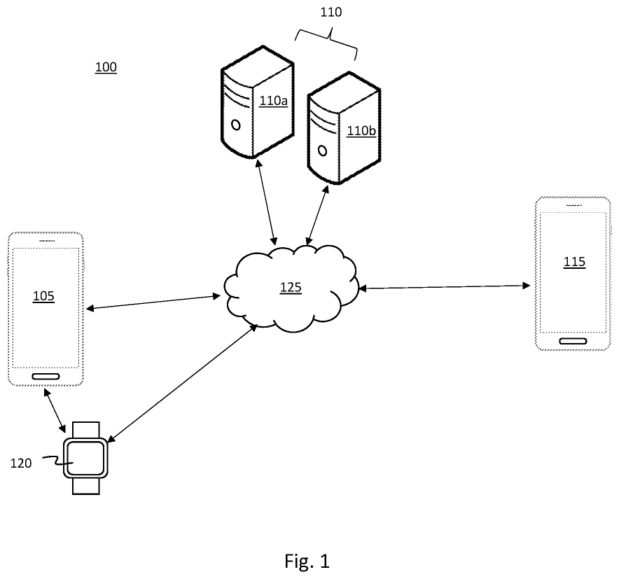

FIG. 1 illustrates an example system 100 for providing a communication link between a client device and a helper device, in accordance with some aspects. The system 100 includes a client device 105 and a helper device 115. The client device 105 and helper device 115 may be smart phones, such as illustrated in FIG. 1, or may be any computing device such as a personal computer, a tablet computer, a wearable device, such as a smart watch, a virtual reality device, such as a VR headset, and so forth. The client device 105 and helper device 115 are connected to each other through a network connection 125 which may be an Internet connection, a personal network, a private network, a wired network, a wireless network, and so forth. The client device 105 and/or helper device 115 may have a companion device 120, such as a smart watch or the like, tethered thereto which can be used in conjunction with the client device 105 and/or the helper device 115. While only one companion device 120 is illustrated, it should be understood that another companion device 120 may be used with the helper device 115. The companion device 120, if used, may optionally be in direct communication with the client device 105 and/or helper device 115 via a personal network, such as Bluetooth™, or may be connected at a private network, public network, Internet, and so forth. The system 100 also includes a server system 110, such as servers 110a and 110b, which may communicatively interact with the client device 105 and helper device 115. The server system 110 facilitates the transactions between the client device 105 and helper device 115.

Although only one client device 105 is illustrated and one helper device 115 is illustrated in FIG. 1, it should be understood that any number of client devices 105 and/or helper devices 115 may be communicatively coupled to the server system 110 and to each other as the system 100 facilitates communications therebetween.

The system 100 can include a registration module for registering clients and/or helpers to have accounts associated with their respective client devices or helper devices. In some embodiments, an account fee can be charged to maintain a client or helper account. In some embodiments, a free tier of service may be available, and fees may be charged to advanced clients who want more customizable features. In some embodiments, system, usage, or transaction fees may be charged to the clients and/or the helpers. For example, in some instances, fees may be deducted from the amount provided to the helpers and the helpers can account for these fees by adjusting their rates to offset the fees to achieve the final rate they desire. In other instances, fees may be charged to the clients, so that, whenever a charge or pre-authorization is performed as described herein, the fees are added to the pre-authorized amount automatically. This also applies to sales taxes required, if applicable. In some instances, the fees are split in some manner between the helper and the client. Whatever the fee structure used, it should be understood that when charges or pre-authorizations are discussed herein, the disclosure contemplates incorporating the fee structure and taxes into the transactions. In some embodiments, transaction fees for clients can be offset or avoided by membership pricing tiers when the clients maintain a paid account with the helper server. The membership pricing tiers can include bands of use such as “up to 100 minutes per month,” “between 100 and 1000 minutes per month,” and so forth.

The system 100 can include an auction and scheduling module in addition to an on-demand module. While the discussion below generally contemplates the use of an on-demand module, it will be appreciated that the steps described below can be modified to allow for use in connection with a scheduling module or auction module. A scheduling module allows helpers to post their expected availability and clients can schedule helper conferences at particular times. In such embodiments, the scheduling module can utilize a calendaring system to provide appointment times. As appointment times approach, the scheduling module can notify the client device and the helper device to be ready at the appointed time. Client devices may be required to submit payment in advance so that if they do not show up for the appointment the available helper is still remunerated for setting aside the time.

The auction module provides a bidding interface which allows different clients operating different client devices to bid on scheduling time slots in an auction format. A high bidder at the time the auction ends is scheduled to meet with the helper at the appointed time.

The system 100 can facilitate a many-to-one solution where two or more client devices simultaneously connect to a helper device. In such a way, an impromptu teaching experience can be created where a cohort of clients each learn from a helper or expert in a particular subject. In such embodiments, the helper system can provide connection information (as described below) to each of the client devices connecting to the helper device are able to connect. The client and helper devices can communicate by any suitable real-time communication protocol, such as for example, web real-time communication. Thus, the helper system can provide connection information to each of the helper and client systems for using the real-time communication protocol. Such connection information can include information for enabling any suitable peer-to-peer connection protocol, such as interactive connectivity establishment (ICE), relying on Session Initiation Protocol, Extensible Messaging and Presence Protocol (XMPP), Message Queuing Telemetry Transport, Matrix, or another protocol.

Various examples are provided here for the kind of help that a client might request from a helper using system 100.

Expert help: “I need help with my car/computer/health/plumbing/legal problem, and I want quick advice or guidance.” Solution: Experts can declare their services and rates on the platform; they can provide advice immediately upon requests through video or audio chats. The askers do not need to wait for a call-back or speak to a receptionist before reaching the experts. In many cases, quick chats lasting for just a few seconds or minutes can suffice or provide the necessary guidance. The payment will be made automatically upon completion.

Expert help: “I have a job/business-related question.” Solution: Experts and experienced workers can sell advice on the platform. Unlike consulting firms whose services are costly and involve heavy overheads, the individual sellers on the platform can offer quick and effective advice on specific questions.

Expert help: “I have a tax-related inquiry.” Solution: Such questions often involve complex situations for which there are no straightforward online responses. Thanks to the platform, interactive dialogues with helpers will be highly beneficial.

Expert help: “How can I translate this word/sentence? The machine translation is not particularly accurate.” Solution: A few seconds or minutes of conversation with an expert on the platform will suffice.

Expert help: “I need help with my study question.” Solution: Experts and fellow students can offer help via the platform.

Expert help: “I want someone to search the internet for me, report the results, and then answer any follow-up questions I may have by conducting more searches in an interactive manner.” Solution: Search experts can offer help through the platform and significantly increase the value of the Internet.

Know-how: “How to register a patent, and what are the tips?” Solution: Frequently, one still has unresolved questions after conducting an Internet search. Experts or experienced patent holders can offer advice and answer personalized questions effectively via the platform.

Know-how: “How to make a certain meal?” Solution: Like many other examples on the list, the asker does not necessarily need an expert to help. People with relevant experience or skills can offer help via the platform.

Know-how: “How to build a website?” Solution: Experts or experienced people can offer help via the platform.

Know-how: “How to publish a book?” Solution: Experts or experienced people can offer help via the platform.

Know-how: “What are the tips for doing a garage sale?” Solution: Such requests are not expert-related and are thus difficult to find advice for. Experienced individuals can share tips and unlock the knowledge through the platform.

Know-how: “What are the steps and tips for obtaining a flight pilot/gun ownership license?” Solution: Experts or experienced people can offer help via the platform.

Leisure: “I am seeking information on traveling to a specific destination.” Solution: Both experts and non-experts can offer travel advice via the platform.

Leisure: “Can someone tell me a joke?” Solution: It is difficult for people to earn a living by telling amusing jokes as a career using conventional markets. However, the platform makes it a lot easier to earn income by telling jokes in a quick and sporadic manner.

Leisure: “I am seeking an idea for a birthday party/Christmas activity/another occasion.” Solution: Anyone with creative ideas can offer help via the platform. This is one of many examples demonstrating the inclusive nature of the platform.

Leisure: “Can someone recommend a good book/movie/video game/other activity?” Solution: Anyone with pertinent ideas can offer help via the platform. This example demonstrates the inclusiveness of the platform, even for non-“experts.”

Insider information: “I am considering sending my child to school X, therefore I want to talk to some students there to know more about it.” Solution: Any student in the school can declare and offer help via the platform. This example demonstrates the inclusiveness of the platform, even for non-“experts.”

Insider information: “I want to talk to someone working in institution X to know more about it.” Solution: Anyone working in the institution can offer help via the platform. This example demonstrates the inclusiveness of the platform.

Insider information: “What does life look like as an accountant/senior citizen/homeless person/musician?” Solution: People of a relevant profile can offer help via the platform. This example demonstrates the inclusiveness of the platform.

Insider information: “I am considering renting an apartment in a specific building, and I want to talk to someone living there.” Solution: Anyone residing in the building can provide valuable insights.

Insider information: “I am considering buying a specific car model, and I want to talk to someone who owns it.” Solution: A current owner can provide helpful insights into the car's performance and user experience, which may not be easily accessible through reviews or online articles.

Daily life questions: “I am seeking a gift idea.” Solution: Anyone with creative ideas can offer help via the platform. This is one of many examples demonstrating the inclusive nature of the platform.

Daily life questions: “How to teach my children?” Solution: This is a very personalized question. Interactive advice shared by experts or fellow parents through the platform will be beneficial.

Discussion: “I have an idea of X, and I want to discuss it with relevant people.” Solution: Experts or experienced individuals can offer help on the platform to evaluate the idea and provide advice for its realization.

Discussion: “I enjoyed a book/article/video, and I want to chat with the author.” Solution: Thanks to the platform, authors can share a link to the platform where they offer to chat with readers for a fee. (Meanwhile, they can still reply to readers' correspondences in the traditional way.) In fact, the fee acts as an efficient filter for the authors to pick up valuable requests, and it also offers a practical means for enthusiastic readers to reach the authors.

Discussion: “I am a fan of movie X/sports team X, and I want to chat with fellow enthusiasts.” Solution: Fellow fans can offer chat on the platform.

Celebrity meetup: “I desire to see/speak with celebrity X.” Solution: Celebrities can sell video chat sessions with fans on the platform. It will be more efficient and much cheaper than traditional means, such as hosting a charity lunch. Selling may be done using an auction style scheduling service or a scheduling service that requires upfront payment.

Celebrity meetup: “A celebrity wants to meet fans and raise funds.” Solution: The same as above, and both celebrities and fans can benefit.

Situational advice: “I just arrived at city X. Can someone suggest a three-hour tour itinerary?” Solution: This is a personalized question. Both experts and non-experts can offer help through the platform.

Personal experiences and advice: “I am experiencing a breakup, and I want someone to talk to.” Solution: People with sympathetic ears can offer advice and comfort.

Personal experiences and advice: “I want to quit smoking, and I would like to talk to someone who has successfully quit.” Solution: Anyone who has quit smoking can provide valuable advice and encouragement for others attempting to quit.

Personal experiences and advice: “I want to learn a new language, and I would like to talk to someone who has already learned it.” Solution: Anyone who has learned the language can provide tips and advice on how to approach it.

Shopping advice: “I intend to buy a drone/3D printer. Can someone provide an introduction and advice on the best model/price/store suitable for me?” Solution: People can offer advice via the platform. A buyer will receive more tailored and compelling guidance by chatting with helpers (product sellers, in some cases, and experienced product owners, in some other cases) than searching online. A product seller can even sell the product directly through chatting with the client.

Shopping advice: “I am looking for a renovation contractor/piano teacher/real estate agent/bank/doctor. Can someone offer recommendations?” Solution: The platform facilitates efficient knowledge-sharing. Buyers will find communicating with experienced people more customized and compelling than searching online.

Shopping advice: “Can someone propose a suitable restaurant for me?” Solution: This is a non-expert question. Anyone with relevant knowledge or experience can offer help through the platform.

Shopping advice: “I need assistance selecting a summer camp for my child.” Solution: This is a non-expert question. Anyone with relevant knowledge or experience can offer help through the platform.

Meeting random individuals: “We are seeking the thoughts of random individuals on our new product design.” Solution: Any people, regardless of skills or knowledge, can announce their availability and price for such services on the platform. The business can then easily contact them for a market survey.

Meeting random individuals: “A psychologist seeking random participants for an experiment.” Solution: Any people can announce their availability and price on the platform. The psychologist can then contact and pick subjects with ease.

Meeting random individuals: “I want to chat with a random person.” Solution: Any person can offer the service of “chat with anyone who (feels lonely and hence) wants to talk.”

Pre-commitment questions and interviews: “I am looking to hire a lawyer, but before that I need to clear some questions and meanwhile interview lawyers.” Solution: lawyers can offer to answer quick questions on the platform, therefore meet potential clients efficiently, which could lead to long-term contracts.

In addition to the above examples, it should be appreciated that the system 100 may be deployed in a private deployment, such as a helpdesk. Client devices can utilize the system 100 to obtain help from technical experts at their place of employment and the like.

Further, while the system 100 is described below with respect to embodiments assuming a financial benefit to helpers, it should be understood that helpers can also provide free services. For example, helpers who volunteer for mental health crisis can provide free services or helpers who are affiliated with a humanitarian organization, a religious organization, or the like may want to provide free helper services.

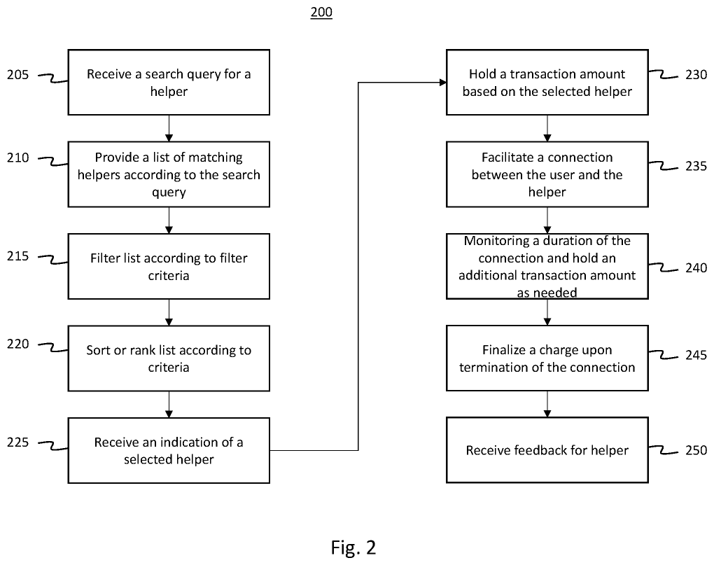

FIG. 2 illustrates a flow diagram for a process 200 for receiving a help request and providing a communication link between a client device and a helper device, in accordance with some aspects. Although the flow is presented in a particular order, it should be understood that some of the elements may be executed in any order or simultaneously where logically possible. Some elements may be omitted and/or are optional. The flow for the process 200 may be performed by an electronic device, such as associated with the server system 110, which may be an electronic device in accordance with the electronic system 600, described below.

At 205, a search query is received from a client device, such as client device 105, at a server device, such as server system 110, for a helper. The search query may be input, for example, at the client device, at an interface provided on the client device. The interface may be available at a web page or an application installed on the client device. The search query may be a natural language query (NLQ) or a keyword search query. If the client knows the nickname, name, or handle of the helper, then the search query may be for that nickname, name, or handle.

At 210, the server device may return to the client device a list or partial list of matching helpers. The list may include a name, nickname, or handle for the helper, an icon or photograph representation of the helper, a brief description of the helper, a contextually relevant portion of a description of the helper, an and an availability status of the helper. The list may also include instructions for formatting and displaying the list on the client device. The list may include a data structure format, for example, in key/value pairs that include the above information as well as additional information as necessary. The client device may be configured to display the key/value pairs according to a pre-defined layout of a client interface displayed at the client device. The list may only be partially displayed and a client of the device may interact with the interface to scroll the list to display additional results or navigate to another page of partial results.

The availability status for each of the helpers may be one of available, unavailable and away, unavailable and present. The client may not see a distinction in the client interface between unavailable and away and unavailable and present.

At 215, the list may be filtered according to a filter criterion. For example, initially the list may be filtered to exclude results where the status of the helper is unavailable (both unavailable and away and unavailable and present). The client interface may also provide controls which may be manipulated by the client to filter out other available helpers or to show the unavailable helpers. For example, the client may filter out helpers which have a price above or below a certain threshold, helpers which are geographically distant (e.g., beyond a certain threshold distance away from the client device), helpers which have or fail to have certain affiliations, certificates, or degrees, helpers who have a rating below a certain threshold, helpers who are less active on the platform, helpers who haven't helped anyone in for more than a week or month, etc., helpers who are identity verified, and so on. In some implementations, the filter selections can be provided by the client device and received at the server, and the server can provide an updated list to the client device. In some implementations, filters can be provided in conjunction with the search so that the matching helpers returned (for example, at 210) includes only filtered results.

At 220, the list may be sorted or ranked according to certain criteria. The criteria may be the same or other criteria as those described above. In one aspect, the server may return a ranked list, where the ranking accounts for several factors which are blended together to provide more relevant helpers listed toward the top of the list. For example, helpers which are more active or more available than helpers which are not may be preferred toward the front of the list. Helpers which have higher ratings may be toward the front of the list. Helpers which have shorter interaction times, for example, as compared to other helpers in the system or other helpers in the same subject matter discipline in the system may be toward the front of the list. Helpers who have verified identities may be toward the front of the list. Helpers who have more robustly completed profiles may be toward the front of the list. Helpers who have a photograph may be toward the front of the list. Helpers who use video vs. only audio may be toward the front of the list. More conditions can be used for rankings, e.g., last log in (the recent the better), geographic distance from the client, spoken language, average call length (shorter generally being preferred), client's profile and historical activity (where potential helpers who have overlapping or similar preferences as the client are preferred). The various criteria can be blended together to come up with an overall ranking system.

In one aspect a machine learning model can be trained with helper data, query data, and client selection data to provide different clusters of helpers. The list may be ordered based on a query to the machine learning model which can provide relevant results based on the output of the machine learning model.

At 225, after a client makes a selection on the client interface at the client device, the client device sends a selection to the server device. Thus an indication of the selected helper is received at the server device. The indication indicates which helper is selected by the client.

The server may then provide a more detailed profile of the helper. In some aspects, profile information for the helper can be cross-linked with a social media presence for the helper. The client may choose to go back to the list to select a different helper or may select an option to continue to contact the selected helper.

At 230, when the client selects an option to continue to contact the selected helper, a charge transaction or pre-authorization hold is placed on the client-linked payment. The client-linked payment may be set up ahead of time or may be set up at the time of the helper request. The client-linked payment may be from any suitable payment processor. In some aspects, the client-linked payment may be reserved from a current client balance in the system 100.

The amount of the pre-authorization transaction may be related to the rate set by the helper, for example, a value corresponding to 30 seconds to 10 minutes of talk time at the helper's rate, though other values are contemplated and may be used. The block of time corresponding to the pre-authorization may be a pre-determined block of time selected by the system. In some implementations, the block of time may be selected by the helper and/or client. For example, the block of time may be a configurable parameter specified by the helper or the block of time may be a configurable parameter specified by the client when the client initiates the session. In some embodiments, the platform may default to a 5 minute block of time and pre-authorize a payment equivalent to the 5 minute block of time at the helper's rate. In some embodiments, the helper may indicate a preference to the platform that they would like the pre-authorized period of time to be anywhere from about 1 minute to about 60 minutes. Then the platform would pre-authorize or pre-charge the client based on the rate of the helper and the selected period of time, such as 5 minutes or 300 seconds. In other aspects, the pre-pay or pre-authorization may be a fixed amount selected by the helper or the system. In some embodiments, the platform may allow the client to select the pre-authorization time period by providing the client with options within the range selected by the helper. If the time used is less than the pre-authorized time period, by either the client or helper ending the session, then the client will be refunded the unused portion and/or will only be finally charged for the used length of the session. If the time used would exceed the pre-authorized time period, then either the system may end the session automatically or the client can be charged or pre-authorized an additional charge for the same period of time again or a different period of time.

At 235, after the payment authorization or pre-authorization hold, the system can facilitate a connection between the client and the helper. For example, the system may provide to the client and to the helper, connection information, i.e., information for establishing a real-time direct peer-to-peer connection between the client and the helper using the communications protocols listed above, or the like. When the helper device receives a request from the client device to connect, the request can be made via a peer-to-peer connection protocol to establish a real-time connection between the client and the helper.

The application or web page at the client device and an application or web page at the helper device can include a video and/or audio-conferencing function for providing real-time communication capabilities between the connected helper device and client device. If either the helper device or the client device ends the conference, then the session is ended.

If the helper is available or unavailable but willing to accept connection requests (stealth), then the helper device can be sent the peer-to-peer connection information. If the helper is unavailable and unwilling to accept connection requests, the helper device is not sent the connection information and connection information may or may not be sent to the client.

At 240, the server device can monitor the duration of the connection or conference. In some embodiments, if the duration is approaching the pre-authorized hold or payment authorization, then, when the allotted time or funds are is used, the call will terminate. In some embodiments, if the duration is approaching the pre-authorized hold or payment authorization, another pre-authorization hold or payment authorization can be made by the system. The amount of the second or subsequent pre-authorized hold or payment authorization can be the same or different than the first one. The current cost of the conference can be provided to the client device for display at the client interface of the client device. The cost can be updated at the client device interface at the same rate as the time-slice billing increment or may be updated at a multiple of the time-slice billing increment. The monitoring of the connection or conference may be performed by any suitable mechanism. For example, the client device and/or helper device may send periodic heartbeat messages to the server device with timestamp and connection status. The periodic heartbeat messages may be performed at the same rate as the time-slice billing increment or a multiple of the time-slice billing increment.

At 245, upon termination of the conferencing connection between the client device and the helper device, the charges for the call can be finalized and the cost of the call can be transferred from an account associated with the client to an account associated with the helper. The system may charge a commission or transaction fee for providing the service and/or for processing the charges. The client account associated with the client device is charged based on the duration of the conferencing connection, the time-slice billing increment, and the helper rate for the helper. If a pre-authorization was used, the pre-authorization can be released. If a charge was previously incurred, a partial refund can be provided as needed. The connection can terminate by either party ending the session. In some embodiments, the connection can terminate automatically when the pre-authorization or pre-charge is used up. In such embodiments, each party can be given a countdown clock to indicate how much time is yet available in the session, where the time left is based on the pre-authorization or pre-charge, the time elapsed, and the helper rate. As noted above, in other embodiments, the system can recharge or re-authorize an additional charge to the client to maintain the session until it is manually ended by either party.

At 250, feedback can be received from the client of the client device. The client device can be prompted to provide feedback regarding aspects of the conferencing session. For example, the client can rate specific aspects of the helper, such as their ability to communicate, their knowledgeability of the issue at hand, their helpfulness, their friendliness, an assessment of the accuracy of their profile, and so forth. The client can also rate aspects of the technology used, such as video or audio quality, and so forth. The client can also leave specific comments for the helper to view privately and/or for other people to view publicly.

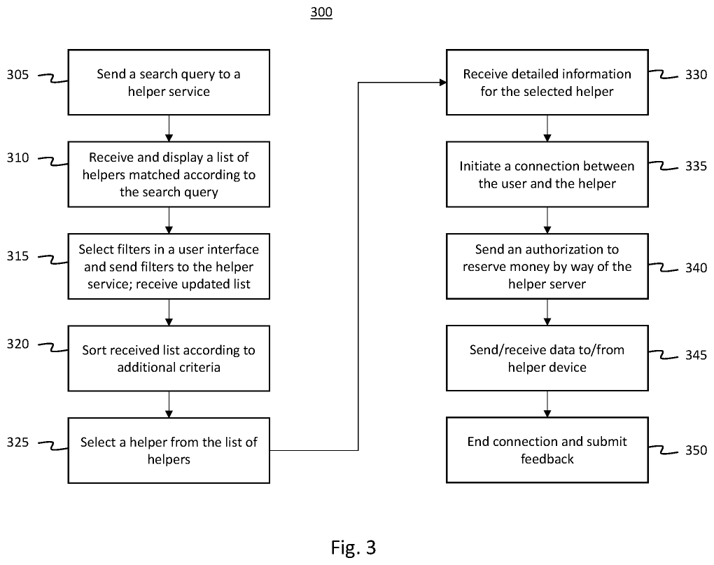

FIG. 3 illustrates a flow diagram for a process 300 for sending a help request from a client device to a helper device and establishing a communication link between the client device and the helper device, in accordance with some aspects. Although the flow is presented in a particular order, it should be understood that some of the elements may be executed in any order or simultaneously where logically possible. Some elements may be omitted and/or are optional. The flow for the process 300 may be performed by an electronic device, such as the client device 105, which may be an electronic device in accordance with the electronic system 600, described below.

At 305, a search query is provided to a helper service, such as the server system 110, from a client device, such as the client device 105. The search query may be provided, for example, by a client of the client device via an input mechanism at an interface of the client device. The client device may then send the query to the helper service via a communications network, such as the network 125. The interface may be available at a webpage or an application installed on the client device. The search query may be a natural language query (NLQ) or a keyword search query. If the client knows the nickname, name, or handle of the helper, then the search query may be for that nickname, name, or handle.

At 310, the client device may receive from the helper service a list or partial list of helper profiles that match the search query. The list and associated descriptions for displaying the list may include the list and processes described above with respect to 210, which is not repeated. The list includes a plurality of helper profiles. Each of the helper profiles can include a snapshot representation of the registered helpers which match the query. The snapshot can include, for example, a profile picture or icon, a name, a clientname, a nickname, a handle, a brief description of an area of knowledge or help domain, a contextual excerpt from a more detailed profile description which is relevant to the search query, one or more ratings for the helper, and a cost rate for the helper. The client device can display all or part of the list of helper profiles as snapshots, where each displayed helper profile is a clickable element.

The snapshot may also include an availability status for each of the helpers which may be one of available, unavailable and away, unavailable and present. The client may not see a distinction in the client interface between unavailable and away and unavailable and present.

At 315, in some embodiments, the list may be filtered according to a filter criterion. In some embodiment, filter criteria may be selected at the client device and indications of the filter criteria sent to the helper service whereupon an updated list is received from the helper service. For example, initially the list may be filtered to exclude results where the status of the helper is unavailable (both unavailable and away and unavailable and present). The client interface may also provide controls which may be manipulated by the client to filter out other available helpers or to show the unavailable helpers. Such filters may be as described above with respect to 215, which are not repeated.

At 320, the list may be sorted or ranked according to selected criteria. The criteria may be the same or other criteria as those described above. In one embodiment, the client device may receive a ranked list from the helper service, where the ranking accounts for several factors which are blended together to provide more relevant helpers listed toward the top of the list. The blended factors are described above with respect to 220 and are not repeated here.

At 325, after a client makes a selection on the client interface at the client device, the client device sends a selection to the server device. Thus an indication of the selected helper is sent to the helper service. The indication indicates which helper is selected by the client.

At 330, the client device may receive, from the helper service, a more detailed profile of the selected helper. In some embodiments, profile information for the helper can be cross-linked with a social media presence for the helper. The detailed profile information may include a full description of the helper, statistics regarding past help experiences with other clients, statistics regarding past help experiences with the client profile associated with the client device, certifications, degrees, licenses, and so forth. The client may choose, using the client interface of the client device, to go back to the list to select a different helper or may select an option to continue to contact the selected helper.

At 335, when the client selects an option to continue to contact the selected helper, at 340, a charge transaction or pre-authorization hold is placed on the client-linked payment. The client-linked payment may be set up ahead of time or may be set up at the time of the helper request. The client-linked payment may be from any suitable payment processor. In some embodiments, the client-linked payment may be reserved from a current client balance in the system 100.

As noted above, the amount of the payment may be related to the rate set by the helper, for example, a value corresponding to 30 seconds to 5 minutes of talk time at the helper rate, though other values are contemplated and may be used. For example, if the helper rate is $0.15 per second then a charge for 5 minutes of time may be reserved or charged at $45 (5×60×$0.15). The client device may send an authorization to the helper service to initiate a pre-authorization hold or an account charge.

In some embodiments, the helper may show as unavailable. However, the helper may have set the displayed availability as unavailable while they are actually available and are in a stealth mode. In such instances, the client device can still try to connect to the helper. If the helper is truly unavailable, then the connection will fail. Likewise, if the helper is actually available, but does not respond, the connection will fail. However, if the helper is actually available, and does respond, then the helper device and client device can be connected in a conference communication.

Returning to 335, the client device can receive, from the helper service, connection information for connecting to the helper device. Then, the client device can initiate the connection using the connection information. In some embodiments, connection information is also sent to the helper device from the helper server. The helper device can determine whether to allow connection based on the settings the helper has specified. Other connection and authentication processes are contemplated.

At 345, after the payment authorization or pre-authorization hold and after receiving a link for contacting the helper device, the client device can send and receive data to and from the helper device. The application or web page at the client device and an application or web page at the helper device can include a video and/or audio-conferencing function for providing real-time communication capabilities between the connected helper device and client device. If either the helper device or the client device ends the conference, then the session is ended. A heartbeat signal can be sent to the helper service periodically to inform the helper service that a connection is ongoing, or when the connection is closed a message can be sent to the helper service to indicate that the conference session is terminated.

If the client of the client device would like to end the conferencing session with the helper device, a client interface on the client device can provide a button or input, which when pressed, for example at 350, ends the session. For helpers, this incentivizes the helpers to provide helpful information in a timely way and to not embellish their expertise or experience in a particular area. For clients, this provides the ability to incur very little risk to vet helpers when the time-slice billing increment is small, for example 5 seconds or less, or actual time billed to a precision of less than one second, as noted above. It is noted that helpers may also end the session at any time, as described in further detail below.

After the session is ended, the client can be prompted to provide feedback to the helper service regarding the helper that was used and/or the service itself. The feedback can be sent to the helper service.

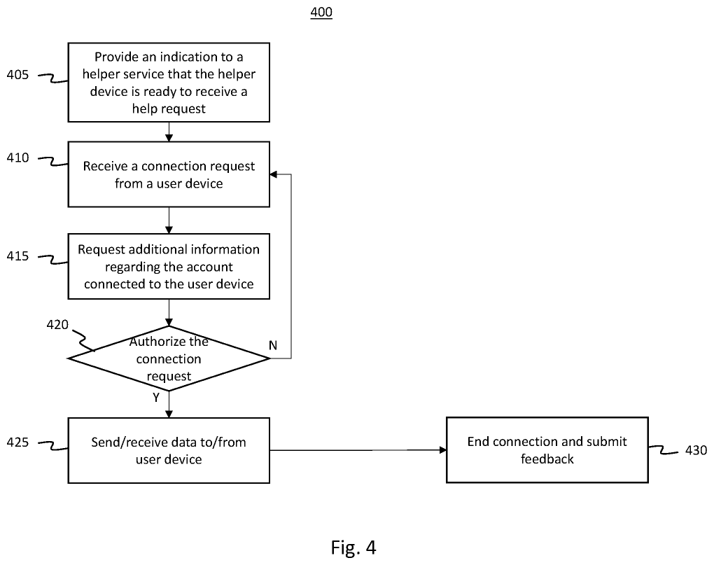

FIG. 4 illustrates a flow diagram for a process 400 for providing help at a helper device, such as helper device 115, to a client at a client device, such as client device 105. At 405, an indication is provided to a helper service, such as server system 110, that the helper device is ready to receive a help request. Essentially a helper operating the helper device can indicate on an application running thereon that the helper device is available to receive a connection request from a client device operated by a client seeking help from the helper at the helper device. The indication can be as described above, available, unavailable but willing to accept connection requests (stealth), or unavailable and unwilling to accept connection requests. In the first two instances, the helper device may be contacted in a subsequent step by a client device, however, in the third instance, the helper device may not by contacted.

At 410, some indeterminate time later, the helper device receives, from the client device a request to connect. The request may include a peer-to-peer connection information which is provided to the client device and to the helper device from the helper server. Upon receiving the connection request from the client device and/or connection information from the helper server, the helper device can trigger an alert at the helper device that a connection request has been received.

At 415, the helper device can provide the helper with the opportunity to receive more information regarding the client account which corresponds to the client device that is trying to connect. For example, if the client account has flags indicating previous misbehavior, nonpayment, chargebacks, etc., then the helper device may wish to decline the connection. To that end, the helper device can request additional information regarding the account associated with the client device from the helper service, which is subsequently received at the helper device. In some embodiments, this request may occur automatically based on the previously saved settings by the helper. In some embodiments, the helper device does not have the opportunity to receive additional information regarding the client account. From the helper's perspective, the payment to connect is guaranteed and the helper can end the session at any time. If the client has engaged in bad behavior, then the platform can remove the client as a user. Thus, the client is at least somewhat vetted. In such embodiments, the step 415 can be omitted.

At 420, the helper device determines whether the connection request is authorized. As noted above, the helper at the helper device may wish to decline the connection. Also, if the helper is in stealth, the helper may not wish to take a help connection requests at that moment. If the connection is declined, the flow can go back to 410 to wait until a connection request is received from another client device.

If the connection is authorized, then the connection is made and at 425 a conferencing connection is made between the client device and the helper device and data is sent/received to/from the client device.

At 430, the helper device may provide to the helper an input at the interface of the helper device to receive a command from the helper to end the connection. The helper may want to end the connection, for example, if the client device (or client in control of the client device) breaks one of the terms of service, for example by presenting inappropriate or offensive material to the helper. If either the helper device or the client device ends the conference, then the session is ended. A heartbeat signal can be sent to the helper service periodically during the session with the client device by the helper device to inform the helper service that a connection is ongoing, or when the connection is closed a message can be sent to the helper service to indicate that the conference session is terminated.

After the session is ended, in some embodiments, the helper can be prompted to provide feedback to the helper service regarding the client that was interacted with and/or the service itself. The feedback can be sent to the helper service. In some embodiments, the client may not be rated by the helper.

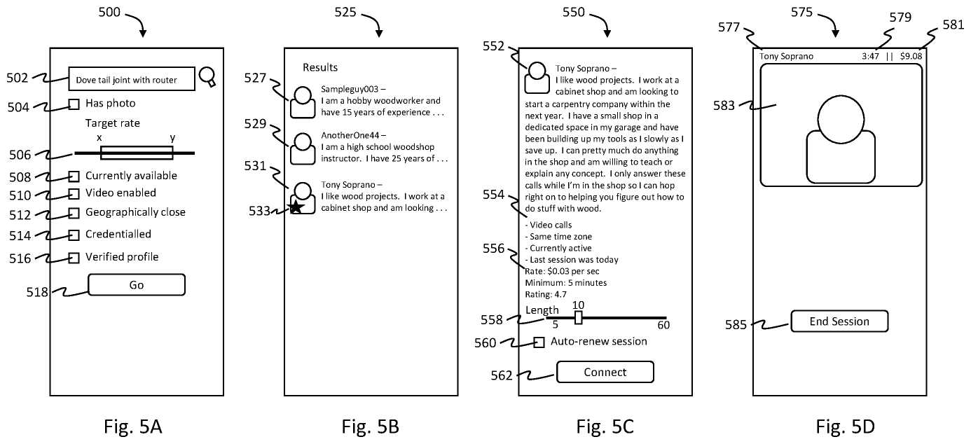

FIGS. 5A, 5B, 5C, and 5D illustrate example user interfaces 500, 525, 550, and 575, respectively, which may be used by a client to find and connect with helpers, such as discussed above with respect to FIG. 3. FIG. 5A, for example, illustrates a sample user interface 500 for searching for available helpers. In the example of FIG. 5A, the user interface 500 can include a search box 502, which can accept a user input search query. In the example illustrated, the search query is “Dove tail joint with router.” Elements 504, 506, 508, 510, 512, 514, and 516 illustrate some of the available filters that may be applied by the user prior to (or after) submitting the search request. Other filters may be used, such as discussed above, which are not repeated. The Go button 518 provides a mechanism for the user to press or click the button to begin searching. Element 504 is a filter that a client can select to indicate that the client only wants results returned where the helper has included a photo for the helper's profile. Element 506 is a filter that a client can use to select a band of acceptable rates, including a minimum rate x and/or maximum rate y. The client, for example, can interact with the slider to indicate the upper and/or lower bounds corresponding to x and y, respectively. Then results can be returned which meet that filter criteria in addition to any other filter criteria.

Element 508 is a filter that a client can select to indicate that the client only wants results returned where the helper is currently available to take a session. For example, if time is of the essence, the client may want to eliminate helpers that are not currently available from consideration. Element 510 is a filter that a client can select to indicated that the client only wants results returned where the helper has video sessions enabled. Element 512 is a filter that a client can select to indicate that the client only wants results returned where the helper is geographically close or is in the same time zone as the client. Element 514 is a filter that a client can select to indicated that the client only wants results returned where the helper is credentialed with a certificate or degree relevant to the helper's participation on the platform. Element 516 is a filter that a client can select to indicated that the client only wants results returned where the helper has had their profile verified so that it is trusted by the system.

FIG. 5B illustrates a user interface 525 which may follow from the user interface 500 and present a user interface following the execution of the search to display search results. Element 527, 529, and 531 are example helpers which may be returned by the search results. Element 527 is for a user ID “Sampleguy003.” A user picture or icon (if available) can be shown along side the helpers returned by the search query. A brief description may also be illustrated. Element 529 is for a user ID “AnotherOne44,” which also includes a picture or icon and a brief description. Element 531 is for a user “Tony Soprano,” which also includes a picture or icon and a brief description. The validation indicator 533, in this case a star, may indicate that the helper is verified. Thus, the verified helper may indicate for display their actual verified name rather than a user ID. Other information may be provided along with the information currently applied. A client can interact with the user interface 525 to select helpers to display additional information, in some embodiments.

FIG. 5C illustrates a user interface 550 which may follow from the user interface 525, for example, when a client selects a potential helper to obtain additional information. Element 552 may include the profile photo or icon, the name, and a fuller synopsis of the helper. Feature region 554 indicates which features of the helper profile are pertinent to the session. For example, the feature region 554 can indicate that the helper is in the same time zone as the client, that the helper is currently active, that the helper enables their camera for video calls, and that the helper had their last session recently, such as today. The feature region 554 can also include the rate information 556, a minimum time length (if specified) and the helper rating information. A slider control can allow, in some embodiments, the client to specify a length of time or actual charge that is to be pre-authorized or pre-charged from the client. The minimum value and maximum values for the slider can be customized based on the settings for that particular helper. For example, the helper can specify a preference for the minimum value and maximum value, which values are used on the slider. If the helper does not set a preference, the system may set default values for the minimum and maximum values. The client can use the slider to select a time between the minimum value and the maximum value, inclusive. The time selected, in this case 10 minutes, by the slider can be provided along with a visual representation of the slider control between the minimum and maximum values. If the slider is for an actual charge, the minimum and maximum values for the charge can be calculated based on the helper's rate and the minimum precharge length. In other embodiments, a client can input in a text field a value for the pre-authorization or pre-charge in terms of their selected currency or in terms of time. A check box 560 can be provided that allows the session to be auto-renewed if the pre-authorized time period is exhausted. If unchecked, the session will end automatically when the pre-authorization time period is used up. A connect button 562 can be used to initiate a session with the helper. The minimum time limit in some embodiments guarantees the helper the minimum allotted time.

FIG. 5D illustrates a user interface 575 which may follow from the user interface 550, for example, when a client initiates a session. FIG. 5D illustrates a name holder 577 which holds the name or user ID for each of the sessions. If the helper is verified, the helper's real name or nickname can be displayed otherwise the user ID for the helper can be displayed. The session clock 579 tells the client exactly how much time has elapsed for the session or alternatively or in addition, how much time is left in the pre-authorized time of the session. In embodiments which delay the start of the clock, for example, to allow for a brief introduction period or for parties to exchange pleasantries, the clock can start some time after the session is begun. Similar, the meter 581 displays the cost of the session in real-time. The cost can be inclusive of platform fees and/or sales tax, in some embodiments, while in other embodiments, the cost displayed on the meter only includes the fees for the helper. An interface 583 provides a video interface with the helper so that the user can see the helper during the session. The button 585 provides the ability for the client to end the session at any time.

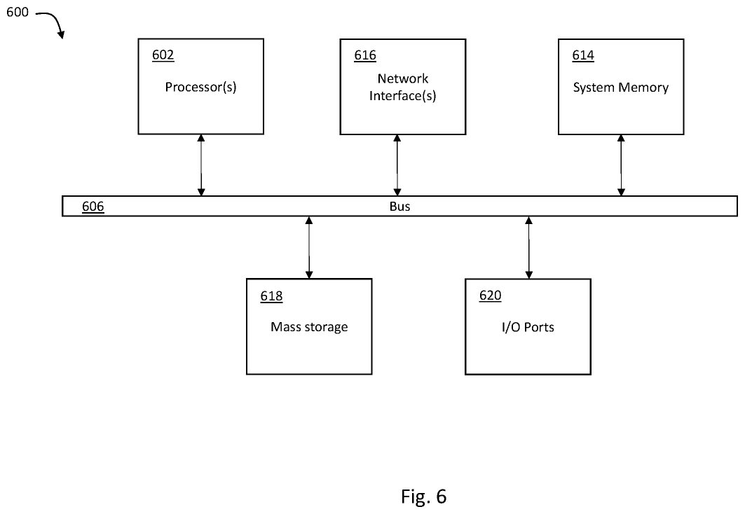

FIG. 6 illustrates an example of an electronic system 600 that may be used to implement one or more of the embodiments described herein in accordance with an embodiment of the invention. In particular the electronic system 600 may correspond to one or more of the client device 105 of FIG. 1, the servers 110, the helper device 115, and/or the companion device 120. The electronic system 600 includes instructions which when executed by a processor cause the electronic system 600 to perform the processes, features, and flows, e.g., operations, discussed herein.

The electronic system 600 can include one or more processors 602, and one or more executable modules and drivers, stored on a computer-readable medium, directed to the processes and features described herein. Additionally, the electronic system 600 may include one or more busses 606, including for example, a high-performance input/output (I/O) bus and/or a standard I/O bus, which are illustrated as a combined bus for the sake of simplicity. The processor 602, system memory 614, one or more network interfaces 616, mass storage 618, and I/O ports 620 are coupled to the bus 606. The electronic system 600 may further include video memory and a display device coupled to the video memory (not shown). The electronic system 600 may optionally include a keyboard and pointing device, a display device, microphone, speakers, or other input/output devices (not shown) coupled to the bus 606. The I/O ports 620 may enable, for example, the display of images generated by electronic system 600. Output devices that may be used with the I/O ports 620 may include, for example, printers and display devices, such as a VR display, liquid crystal display (LCD), a light emitting diode (LED) display, an organic light emitting diode (OLED) display, a flexible display, a flat panel display, a solid state display, a projector, or any other device for outputting information. One or more embodiments may include devices that function as both input and output devices, such as a touchscreen. Input from the client can be received in any form, including acoustic, speech, or tactile input.

The network interface 616 provides communication between the electronic system 600 and one or more networks, such as an Ethernet (e.g., IEEE 802.3) network, etc. Network interface 616 may provide communications over a wired and/or wireless communication link. The mass storage 618 provides non-volatile storage for the data and programming instructions to perform the above-described processes and features implemented by the respective computing systems identified above. The system memory 614 (e.g., DRAM) provides volatile temporary storage for the data and programming instructions when executed by the processor 602. The memory 614 and mass storage 618 are considered non-transitory. The I/O ports 620 may provide communication between additional peripheral devices, which may be coupled to the electronic system 600.

The illustrated electronic system 600 is intended to depict a general computer system and one skilled in the art will understand that a variety of system architectures, and various components of the electronic system 600 may be rearranged. In general, the processes and features described herein may be implemented as part of an operating system or a specific application, component, program, object, module, or series of instructions referred to as “applications”. For example, one or more applications may be used to execute specific processes described herein. The applications typically comprise one or more instructions in various memory and storage devices in the electronic system 600 that, when read and executed by one or more processors, cause the electronic system 600 to execute the processes and features described herein. The processes and features described herein may be implemented in software, firmware, hardware (e.g., an application specific integrated circuit), or any combination thereof.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar storage medium; or any type of medium suitable for storing, encoding, or carrying a series of instructions for execution by the computer system 1200 to perform any one or more of the processes and features described herein.

A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. The term “computer program product” refers to a machine, system, device, and/or manufacture that includes a computer-readable storage medium.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as DRAM, RAM, SRAM, SDRAM, and the like. The computer-readable medium also can include any non-volatile semiconductor memory, such as ROM, PROM, EPROM, EEPROM, NVRAM, MRAM, and the like.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In one aspect, a method may include receiving, from a second device to a first device, a search query for a helper profile. Search results may be provided, from the first device to the second device, responsive to the search query, the search results including a plurality of helper profiles based on the search query. An indication may be received of a selection of a first helper profile of the plurality of helper profiles. A request may be received to communicatively connect the second device to a third device. A connection configuration may be generated for the second device to connect to the third device and the connection configuration may be sent to the second device. A first signal may be received from the second device or the third device, the first signal indicating that a connection is established between the second device and the third device. A second signal may be received from the second device or the third device, the second signal indicating that the connection is terminated. An account associated with the third device may be updated to indicate a payment to the account.

Implementations may include one or more of the following features. The method where the payment is based on a services rate associated with the third device, a duration of the connection, and a billing increment. The method where the billing increment is between 1 second and 5 seconds. The method may include: filtering the search results based on a filter input received from the second device; and providing updated search results based on the filter input. The method may include: ranking the updated search results based on one or more of rating, activity level, last time seen, rate, and availability. The method where the first helper profile indicates that a helper associated with the first helper profile is not an expert. The method where the first helper profile and a second helper profile of the plurality of helper profiles indicate a respective first service rate and a respective second service rate, where the first service rate was previously set by a first client associated with the first helper profile, where the second service rate was previously set by a second client associated with the second helper profile, where the first service rate and the second service rate have different values. The method may include notifying a fourth device and a fifth device of an upcoming scheduled session between the fourth device and the fifth device. The method may include: after receiving the request to communicatively connect the second device to the third device, performing a pre-authorization transaction prior to receiving the first signal. The method where the pre-authorization transaction reserves first funds from an account associated with the second device. The method may include when an estimated cost of the connection exceeds a value of the first funds, performing another pre-authorization transaction while the connection is active so that a total amount pre-authorized exceeds the estimated cost.

In one aspect, a non-transitory machine-readable medium may store instructions that, when executed by one or more processors, cause the one or more processors to perform operations including providing, from the first device to the second device, responsive to the search query, search results including a plurality of helper profiles based on the search query. The instructions may also include receiving an indication of a selection of a first helper profile of the plurality of helper profiles. The instructions may furthermore include receiving a request to communicatively connect the second device to a third device. The instructions may in addition include generating a connection configuration for the second device to connect to the third device and sending the connection configuration to the second device. The instructions may moreover include receiving a first signal from the second device or the third device, the first signal indicating that a connection is established between the second device and the third device. The instructions may also include receiving a second signal from the second device or the third device, the second signal indicating that the connection is terminated. The instructions may furthermore include updating an account associated with the third device to indicate a payment to the account.

Implementations may include one or more of the following features. The instructions where the payment is based on a services rate associated with the third device, a duration of the connection, and a billing increment. The instructions where the billing increment is between 1 second and 5 seconds. The instructions where the operations further may include: filtering the search results based on a filter input received from the second device; and providing updated search results based on the filter input. The instructions where the operations further may include: ranking the updated search results based on one or more of rating, activity level, last time seen, rate, and availability. The instructions where the first helper profile and a second helper profile of the plurality of helper profiles indicate a respective first service rate and a respective second service rate, where the first service rate was previously set by a first client associated with the first helper profile, where the second service rate was previously set by a second client associated with the second helper profile, where the first service rate and the second service rate have different values. The instructions where the operations further may include, after receiving the request to communicatively connect the second device to the third device, performing a pre-authorization transaction prior to receiving the first signal.

In another aspect, a device may include a memory and at least one processor configured to: receive, from a second device to a first device, a search query for a helper profile; provide, from the first device to the second device, responsive to the search query, search results including a plurality of helper profiles based on the search query; receive an indication of a selection of a first helper profile of the plurality of helper profiles; receive a request to communicatively connect the second device to a third device; generate a connection configuration for the second device to connect to the third device and sending the connection configuration to the second device; receive a first signal from the second device or the third device, the first signal indicating that a connection is established between the second device and the third device; receive a second signal from the second device or the third device, the second signal indicating that the connection is terminated; and update an account associated with the third device to indicate a payment to the account.

Implementations may include one or more of the following features. The device where after receiving the request to communicatively connect the second device to the third device, the at least one processor is configured to perform a pre-authorization transaction prior to receiving the first signal, and where the payment is based on a services rate associated with the third device, a duration of the connection, and a billing increment.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “aspects,” “implementations,” “one embodiment”, “an embodiment”, “other embodiments”, “one series of embodiments”, “some embodiments”, “various embodiments”, or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

As defined herein, the singular forms “a,” “an,” and “the” are intended to include the plural forms as well, unless the context clearly indicates otherwise. As defined herein, the term “another” means at least a second or more. As defined herein, the terms “at least one,” “one or more,” and “and/or,” are open-ended expressions that are both conjunctive and disjunctive in operation unless explicitly stated otherwise. For example, each of the expressions “at least one of A, B and C,” “at least one of A, B, or C,” “one or more of A, B, and C,” “one or more of A, B, or C,” and “A, B, and/or C” means A alone, B alone, C alone, A and B together, A and C together, B and C together, or A, B and C together. As defined herein, the term “automatically” means without manual intervention.

As defined herein, the terms “includes,” “including,” “comprises,” and/or “comprising,” specify the presence of stated features, integers, steps, operations, elements, and/or components, but do not preclude the presence or addition of one or more other features, integers, steps, operations, elements, components, and/or groups thereof. As defined herein, the term “if” means “when” or “upon” or “in response to” or “responsive to,” depending upon the context. Thus, the phrase “if it is determined” or “if [a stated condition or event] is detected” may be construed to mean “upon determining” or “in response to determining” or “upon detecting [the stated condition or event]” or “in response to detecting [the stated condition or event]” or “responsive to detecting [the stated condition or event]” depending on the context.

As defined herein, the term “plurality” means two or more than two. As defined herein, the term “responsive to” means responding or reacting readily to an action or event. Thus, if a second action is performed “responsive to” a first action, there is a causal relationship between an occurrence of the first action and an occurrence of the second action. The term “responsive to” indicates the causal relationship. In general, the term “client” means a human being. The terms first, second, etc. may be used herein to describe various elements. These elements should not be limited by these terms, as these terms are only used to distinguish one element from another unless stated otherwise or the context clearly indicates otherwise.

It should also be appreciated that the specification and drawings are to be regarded in an illustrative sense. It can be evident that various changes, alterations, and modifications can be made thereunto without departing from the broader spirit and scope of the disclosed technology.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more.

What is claimed is:

1. A method comprising:
receiving, from a second device to a first device, a search query for a helper profile;
providing, from the first device to the second device, responsive to the search query, search results including a plurality of helper profiles based on the search query;
receiving an indication of a selection of a first helper profile of the plurality of helper profiles;
receiving a request to communicatively connect the second device to a third device;
generating a connection configuration for the second device to connect to the third device and sending the connection configuration to the second device;
receiving a first signal from the second device or the third device, the first signal indicating that a connection is established between the second device and the third device;
receiving a second signal from the second device or the third device, the second signal indicating that the connection is terminated; and
updating an account associated with the third device to indicate a payment to the account.

2. The method of claim 1, wherein the payment is based on a services rate associated with the third device, a duration of the connection, and a billing increment.

3. The method of claim 2, wherein the billing increment is between 1 second and 60 seconds.

4. The method of claim 1, further comprising:
filtering the search results based on a filter input received from the second device; and
providing updated search results based on the filter input.

5. The method of claim 4, further comprising:
ranking the updated search results based on one or more of rating, activity level, last time seen, rate, availability, video/audio settings, spoken language(s), average call length, distance, or similarity.

6. The method of claim 1, wherein the first helper profile indicates that a helper associated with the first helper profile is not an expert.

7. The method of claim 1, wherein the first helper profile and a second helper profile of the plurality of helper profiles indicate a respective first service rate and a respective second service rate, wherein the first service rate was previously set by a first client associated with the first helper profile, wherein the second service rate was previously set by a second client associated with the second helper profile, wherein the first service rate and the second service rate have different values.

8. The method of claim 1, further comprising:
notifying a fourth device and a fifth device of an upcoming scheduled session between the fourth device and the fifth device.

9. The method of claim 1, further comprising:
after receiving the request to communicatively connect the second device to the third device, performing a pre-authorization transaction prior to receiving the first signal.

10. The method of claim 9, wherein the pre-authorization transaction reserves first funds from an account associated with the second device.

11. The method of claim 10, further comprising:
when an estimated cost of the connection exceeds a value of the first funds, performing another pre-authorization transaction while the connection is active so that a total amount pre-authorized exceeds the estimated cost.

12. A non-transitory machine-readable medium comprising instructions that, when executed by one or more processors, cause the one or more processors to perform operations comprising:
receiving, from a second device to a first device, a search query for a helper profile;
providing, from the first device to the second device, responsive to the search query, search results including a plurality of helper profiles based on the search query;
receiving an indication of a selection of a first helper profile of the plurality of helper profiles;
receiving a request to communicatively connect the second device to a third device;
generating a connection configuration for the second device to connect to the third device and sending the connection configuration to the second device;
receiving a first signal from the second device or the third device, the first signal indicating that a connection is established between the second device and the third device;
receiving a second signal from the second device or the third device, the second signal indicating that the connection is terminated; and
updating an account associated with the third device to indicate a payment to the account.

13. The non-transitory machine-readable medium of claim 12, wherein the payment is based on a services rate associated with the third device, a duration of the connection, and a billing increment.

14. The non-transitory machine-readable medium of claim 13, wherein the billing increment is between 1 second and 60 seconds.

15. The non-transitory machine-readable medium of claim 12, wherein the operations further comprise:
filtering the search results based on a filter input received from the second device; and
providing updated search results based on the filter input.

16. The non-transitory machine-readable medium of claim 15, wherein the operations further comprise:
ranking the updated search results based on one or more of rating, activity level, last time seen, rate, availability, video/audio settings, spoken language(s), average call length, distance, or similarity.

17. The non-transitory machine-readable medium of claim 12, wherein the first helper profile and a second helper profile of the plurality of helper profiles indicate a respective first service rate and a respective second service rate, wherein the first service rate was previously set by a first client associated with the first helper profile, wherein the second service rate was previously set by a second client associated with the second helper profile, wherein the first service rate and the second service rate have different values.

18. The non-transitory machine-readable medium of claim 17, wherein the operations further comprise, after receiving the request to communicatively connect the second device to the third device, performing a pre-authorization transaction prior to receiving the first signal.

19. A device comprising:
a memory; and
at least one processor configured to:
receive, from a second device to a first device, a search query for a helper profile;
provide, from the first device to the second device, responsive to the search query, search results including a plurality of helper profiles based on the search query;
receive an indication of a selection of a first helper profile of the plurality of helper profiles;
receive a request to communicatively connect the second device to a third device;
generate a connection configuration for the second device to connect to the third device and sending the connection configuration to the second device;
receive a first signal from the second device or the third device, the first signal indicating that a connection is established between the second device and the third device;
receive a second signal from the second device or the third device, the second signal indicating that the connection is terminated; and
update an account associated with the third device to indicate a payment to the account.

20. The device of claim 19, wherein after receiving the request to communicatively connect the second device to the third device, the at least one processor is configured to perform a pre-authorization transaction prior to receiving the first signal, and wherein the payment is based on a services rate associated with the third device, a duration of the connection, and a billing increment.
